(19) United States
(12) Patent Application Publication
(10) Pub. No.: US 2026/0116288 A1
(43) Pub. Date: Apr. 30, 2026

(54) CONTROL SYSTEM FOR USER EXPERIENCE ENHANCEMENT DEVICES OF A VEHICLE BASED ON OCCUPANCY

(71) Applicant: GM GLOBAL TECHNOLOGY OPERATIONS LLC, Detriot, MI (US)

(72) Inventors: Hyunwoo LEE, Bucheon (KR); Hyungjun Kim, Seoul (KR); Katherine Christine COTE, Farmington Hills, MI (US)

(21) Appl. No.: 18/925,556

(22) Filed: Oct. 24, 2024

(51) Int. Cl. B60Q 3/70; B60H 3/00; B60N 2/00; B60Q 3/80; H05B 47/125; H05B 47/17

(52) U.S. Cl. CPC B60Q 3/70; B60H 3/0092; B60N 2/0021; B60Q 3/80; H05B 47/125; H05B 47/17; B60Q 2500/30

(57) ABSTRACT

A vehicle includes a driver seat zone and a passenger seat zone including a passenger seat lighting system and a passenger seat occupant sensor. A lighting control module is configured to operate in a first lighting mode and a second lighting mode. In the first lighting mode, the lighting control module is configured to supply power to the passenger seat lighting system during operation of the vehicle. In the second lighting mode, the lighting control module is configured to supply power to the passenger seat lighting system in response to the passenger seat occupant sensor sensing a passenger in the passenger seat zone during operation of the vehicle and not supply power to the passenger seat lighting system in response to the passenger seat occupant sensor not sensing the passenger in the passenger seat zone during operation of the vehicle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicles, and more particularly to a control system for controlling one or more user experience enhancement devices of a vehicle based on user occupancy.

Vehicles may include lighting and/or other devices that are operated when a driver or passenger enters a vehicle or is driving a vehicle to enhance the user experience. An accessory battery typically supplies power to the user experience enhancement devices. During operation of the vehicle, the user experience enhancement devices consume power from the accessory battery.

### SUMMARY

A vehicle includes a driver seat zone and a passenger seat zone including a passenger seat lighting system and a passenger seat occupant sensor. A lighting control module is configured to operate in a first lighting mode and a second lighting mode. In the first lighting mode, the lighting control module is configured to supply power to the passenger seat lighting system during operation of the vehicle. In the second lighting mode, the lighting control module is configured to supply power to the passenger seat lighting system in response to the passenger seat occupant sensor sensing a passenger in the passenger seat zone during operation of the vehicle and not supply power to the passenger seat lighting system in response to the passenger seat occupant sensor not sensing the passenger in the passenger seat zone during operation of the vehicle.

In other features, the passenger seat occupant sensor is selected from a group consisting of a door sensor, a seat belt sensor, a camera, and an occupant classifier.

In other features, the passenger seat occupant sensor includes a passenger door sensor and at least one of a passenger seat belt sensor and an occupant classifier, and the passenger seat occupant sensor senses the passenger in the passenger seat zone in response to the passenger door sensor sensing a door ajar event and at least one of the passenger seat belt sensor sensing a seat buckle event and the occupant classifier sensing the passenger.

In other features, the passenger seat occupant sensor further includes a camera and an image analysis module configured to identify a passenger in one or more images from the camera, and the passenger seat occupant sensor senses the passenger in the passenger seat zone in response to the camera and the image analysis module.

In other features, the vehicle includes a rear seat zone, a rear seat lighting system, and a rear seat occupant sensor. In the first lighting mode, the lighting control module is configured to supply power to the rear seat lighting system during operation of the vehicle. In the second lighting mode, the lighting control module is configured to supply power to the rear seat lighting system in response to the rear seat occupant sensor sensing a passenger in the rear seat zone during operation of the vehicle and not supply power to the rear seat lighting system in response to the rear seat occupant sensor not sensing the passenger in the rear seat zone during operation of the vehicle.

In other features, the rear seat occupant sensor is selected from a group consisting of a door sensor, a seat belt sensor, a camera, and an occupant classifier. The rear seat occupant sensor includes a rear door sensor and a rear seat belt sensor. The rear seat occupant sensor senses the passenger in the rear seat zone in response to the door sensor sensing a door ajar event and at least one of the seat belt sensor sensing a seat buckle event and the occupant classifier sensing the passenger.

In other features, the passenger seat occupant sensor further includes a camera and an image analysis module configured to identify a passenger in one or more images from the camera. The passenger seat occupant sensor senses the passenger in the passenger seat zone in response to the camera and the image analysis module. At least one of the passenger seat lighting system and the rear seat lighting system includes a red, green, and blue (RGB) light emitting diode (LED).

A vehicle includes a passenger seat zone including a passenger user experience enhancement device and a passenger seat occupant sensor. A control module is configured to operate in a first mode and a second mode. In the first mode, the control module is configured to supply power to the passenger user experience enhancement device during operation of the vehicle. In the second mode, the control module is configured to supply power to the passenger user experience enhancement device in response to the passenger seat occupant sensor sensing a passenger in the passenger seat zone during operation of the vehicle and not supply power to the passenger user experience enhancement device in response to the passenger seat occupant sensor not sensing the passenger in the passenger seat zone during operation of the vehicle.

In other features, the passenger user experience enhancement device is selected from a group consisting of a lighting system, a perfume dispensing device, and a display. The passenger seat occupant sensor is selected from a group consisting of a door sensor, a seat belt sensor, a camera, and an occupant classifier.

In other features, the passenger seat occupant sensor includes the door sensor and the seat belt sensor, and the passenger seat occupant sensor senses the passenger in the passenger seat zone in response to the door sensor sensing a door ajar event and at least one of the seat belt sensor sensing a seat buckle event and the occupant sensor sensing the passenger.

In other features, the passenger seat occupant sensor further includes a camera and an image analysis module configured to identify a passenger in one or more images from the camera, and the passenger seat occupant sensor senses the passenger in the passenger seat zone in response to the camera and the image analysis module.

In other features, the vehicle includes a rear seat zone, a rear seat user experience enhancement device, and a rear seat occupant sensor.

In other features, in the first mode, the control module is further configured to supply power to the rear seat user experience enhancement device during operation of the vehicle. In the second mode, the control module is further configured to supply power to the rear seat user experience enhancement device in response to the rear seat occupant sensor sensing a passenger in the rear seat zone during operation of the vehicle and not supply power to the rear seat user experience enhancement device in response to the rear seat occupant sensor not sensing the passenger in the rear seat zone during operation of the vehicle.

In other features, the rear seat occupant sensor is selected from a group consisting of a door sensor, a seat belt sensor, a camera, and an occupant classifier. The rear seat occupant sensor includes a rear door sensor and a rear seat belt sensor, and the rear seat occupant sensor senses the passenger in the rear seat zone in response to the rear door sensor sensing a door ajar event and at least one of the rear seat belt sensor sensing a seat buckle event and the occupant classifier sensing the passenger.

In other features, the rear seat occupant sensor further includes a camera and an image analysis module configured to identify a passenger in one or more images from the camera, wherein the rear seat occupant sensor senses the passenger in the passenger seat zone in response to the camera and the image analysis module.

A vehicle includes a driver seat zone and a passenger seat zone including a passenger seat lighting system and a passenger seat occupant sensor, wherein the passenger seat occupant sensor is selected from a group consisting of a door sensor, a seat belt sensor, a camera, and an occupant classifier. A rear seat zone includes a rear seat lighting system and a rear seat occupant sensor, wherein the rear seat occupant sensor is selected from a group consisting of a door sensor, a seat belt sensor, a camera, and an occupant classifier. A lighting control module is configured to operate in a first lighting mode and a second lighting mode. In the first lighting mode, the lighting control module is configured to supply power to the passenger seat lighting system and the rear seat lighting system during operation of the vehicle. In the second lighting mode, the lighting control module is configured to supply power to the passenger seat lighting system in response to the passenger seat occupant sensor sensing a passenger in the passenger seat zone during operation of the vehicle. The lighting control module is configured to not supply power to the passenger seat lighting system in response to the passenger seat occupant sensor not sensing the passenger in the passenger seat zone during operation of the vehicle. The lighting control module is configured to supply power to the rear seat lighting system in response to the rear seat occupant sensor sensing a passenger in the rear seat zone during operation of the vehicle. The lighting control module is configured to not supply power to the rear seat lighting system in response to the rear seat occupant sensor not sensing the passenger in the rear seat zone during operation of the vehicle. At least one of the passenger seat lighting system and the rear seat lighting system includes a red, green, and blue (RGB) light emitting diode (LED).

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example of a vehicle interior including a driver zone, a front passenger zone, one or more rear passenger zones, and one or more user enhancement devices arranged in the zones according to the present disclosure;

FIG. 2 is a functional block diagram of an example of a control system configured to control the user experience enhancement devices in different zones of the vehicle in response to local occupancy in the zone according to the present disclosure;

FIGS. 3 and 4 are flowcharts of examples of methods for controlling ambient lighting and/or other user experience enhancement devices in different zones of the vehicle in response to local occupancy in the zone.

In the drawings, reference numbers may be reused to identify similar and/or identical elements.

### DETAILED DESCRIPTION

Vehicles may include an enhanced lighting system and/or other devices that are operated when the vehicle is driving. The enhanced lighting and/or other devices enhance the occupant's user experience. However, the lighting or other user experience enhancement devices consume power that is typically supplied by an accessory battery. In some vehicles such as battery electric, fuel cell, or hybrid vehicles, power from a propulsion battery system is used to recharge the accessory battery. As a result, usage of the enhanced lighting system and/or user experience enhancement devices may reduce the range of the battery electric vehicle.

The control system according to the present disclosure selectively provides power to the user experience enhancement devices in a given zone in response to the sensing of a passenger in the corresponding zone. When enabled, power from the accessory battery is consumed by the enhanced lighting systems or other user experience enhancement devices only when an occupant is present in the corresponding zone.

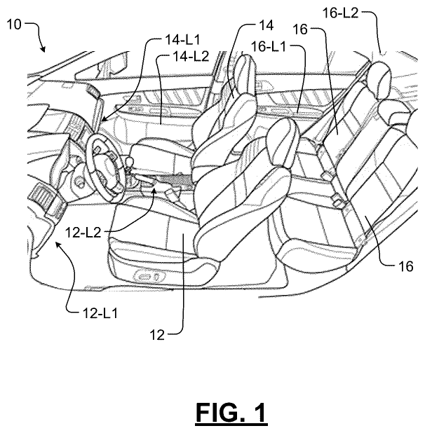

Referring now to FIG. 1, a vehicle interior 10 includes a driver zone 12, a passenger zone 14, and/or one or more rear zones 16. In this example, the user experience enhancement devices include an enhanced lighting system. In some examples, the vehicle is a battery electric vehicle, a fuel vehicle, or a hybrid vehicle that includes a propulsion battery system that provides power to an electric machine for propulsion. In other examples, the vehicle includes an internal combustion engine (ICE) that propels the vehicle.

The driver zone 12 includes interior ambient lights 12-L1, 12-L2, etc. that illuminate selected areas in the driver zone 12. The passenger zone 14 includes interior ambient lights 14-L1, 14-L2, etc. that illuminate selected areas in the passenger zone 14. The one or more rear zones 16 include interior ambient lights 16-L1, 16-L2, etc. that illuminate selected areas in the rear zones 16.

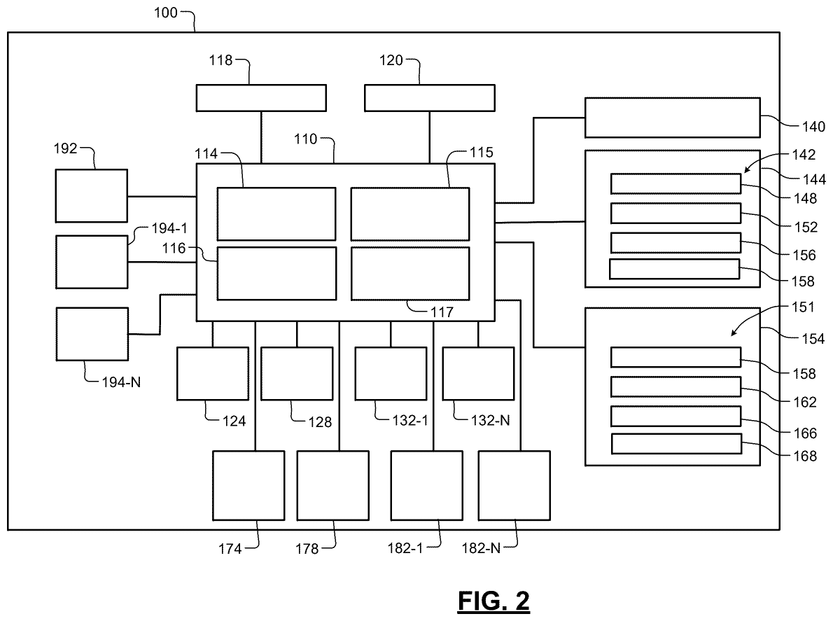

For example, the interior ambient lights 12-L1, 12-L2, 14-L1, 14-L2, 16-L1, 16-L2, etc. in the vehicle interior 10 may include red, green, and blue (RGB) light emitting diodes (LEDs) that are used to illuminate various locations such as an instrument panel, door panel, door trim, foot well, console, and/or other locations in each of the zones. Some vehicles allow the color of the RGB LEDs to be user defined via a user interface such as an infotainment interface. In addition, the vehicle may include other user experience enhancing devices such as perfume dispensing devices, displays for in-vehicle entertainment, etc. that are arranged in the zones as shown in FIG. 2 below. While these devices enhance the user experience, they also consume power.

Manufacturers may hesitate to install enhanced lighting systems or other user experience enhancing devices since these devices consume power. Power consumption is an issue for battery electric vehicles since they rely on a propulsion battery system with a fixed amount of stored power. Minimizing power consumption increases vehicle range. The present disclosure reduces power consumption of the enhanced lighting systems or other user experience enhancing devices by limiting their usage to situations when an occupant is present in a corresponding zone.

Referring now to FIG. 2, a vehicle 100 includes a controller 110 including one or more control modules configured to control one or more user experience enhancement devices in different zones of the vehicle 100 in response to sensed local occupancy. For example, the controller 110 may include a lighting control module 114 to provide enhanced lighting, a display control module 115 configured to control video displays in corresponding zones, and/or a perfume control module 117 configured to control dispensing of perfume in corresponding zones of the vehicle.

The vehicle 100 includes an ignition switch or key sensor at 118 that is configured to receive or sense a key to unlock the vehicle, turn on the vehicle, and/or to turn on an ignition switch. A user interface 120 such as an infotainment system, touchpad, buttons, display, or other device allows an occupant to set user preferences to control the user experience enhancing device(s) (e.g., ambient lighting, displays, and/or perfume dispenser). In some examples, the user interface 120 allows the occupant to select a first mode that selectively enables the user experience enhancement device(s) for a zone only if an occupant is located in the zone and a second mode enables the user experience enhancement device(s) independently of the status of occupants in the corresponding zones.

The lighting control module 114 communicates with driver zone lights 124, front passenger lights 128, and N rear zone lights 132-1 . . . 132-N, where N is an integer greater than zero. The display control module 115 optionally communicates with a passenger display 192 and/or N rear zone displays 194-1, . . . , and 194-N. The perfume control module 117 optionally communicates with a driver perfume dispensing device 174, a front passenger perfume dispensing device 178, and/or N rear zone perfume dispending devices 182-1, . . . , and 182-N, where N is an integer greater than zero. In some examples, the rear zones may include a single seat, row of seats, and/or two or more rows of rear seats.

A passenger seat zone 144 includes one or more devices 142 that can be used to detect the presence of an occupant in the corresponding zone. In some examples, the one or more devices 142 are selected from a group consisting of seat belt sensors 148, door sensors 152, cameras 156, and/or an occupant classifiers 168. In some examples, the occupant classifier 168 includes a weight sensor or other type of sensor arranged in a seat of the vehicle to detect characteristics of a passenger occupying the passenger seat zone 144. The occupant classifier 168 is configured to determine characteristics of the occupant (e.g., weight or size) to adjust operation of an air bag system that can be used. In some examples, the controller 110 further includes an image analysis module 116 configured to detect the presence or absence of an occupant in a zone based on image analysis of one or more images from the camera.

The N rear seat zones 154 also include one or more devices 151 that can be used to detect the presence of an occupant in a particular zone. In some examples, the one or more devices 151 are selected from a group consisting of seat belt sensors 158, door sensors 162, cameras 166, and/or an occupant classifiers 168. A driver seat zone 140 can likewise include seat belt sensors, door sensors, cameras, and/or occupant classifiers (all not shown since the driver of the vehicle is typically present when the key is used to turn the vehicle on).

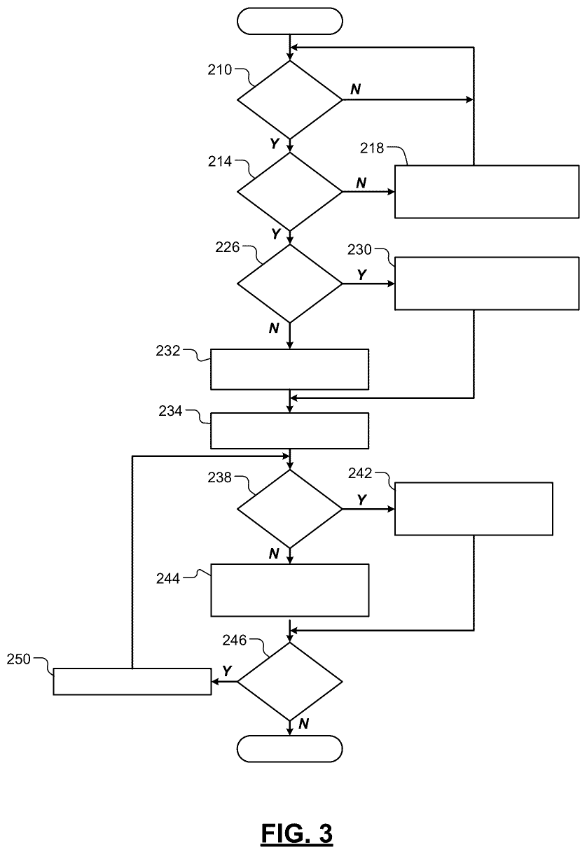

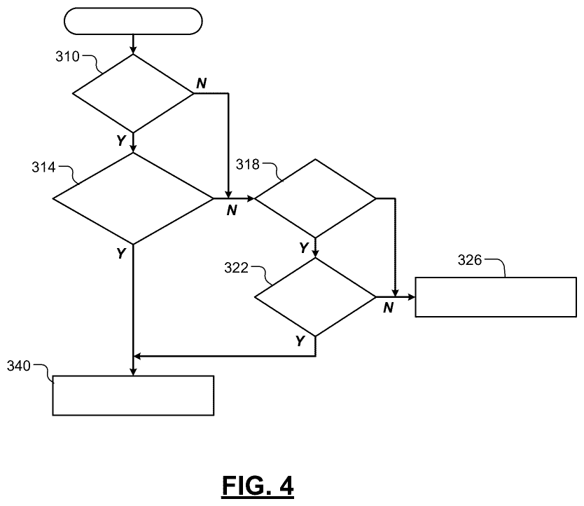

Referring now to FIGS. 3 and 4, a method for selectively controlling user experience enhancement devices (e.g., such as enhanced ambient lighting, perfume dispensers, and/or displays) in different zones of the vehicle in response to occupancy is shown. At 210, the method determines whether the key is detected and/or the vehicle is on. If 210 is true, the method determines whether the mode of one or more of the user experience enhancement devices is set to an occupancy zone mode at 214. As can be appreciated, none, some or all of the user experience enhancement devices can be set to the occupancy zone mode.

If 214 is false, the method enables all of the user experience enhancement devices in the zones (that are not set to an occupancy zone mode) using a standard mode that is not dependent upon passenger occupancy in a particular zone at 218. In some examples, the method may automatically enable the user experience enhancement devices in the driver zone since the driver is normally present by default.

At 226, the method determines whether the passenger zone is occupied. If 226 is true, the method enables the one or more user experience enhancement devices in the passenger zone that were selected at 230. If 226 is false, the method does not enable the user experience enhancement devices in the passenger zone at 232. The method continues from 230 and 232 at 234.

The method selects one of the rear zones at 234 and determines whether the rear zone is occupied at 238. If 238 is true, the method continues at 242 and enables one or more user experience enhancement devices in the corresponding rear zone at 242. If 238 is false, the method does not enable devices in the corresponding rear zone at 244. The method continues from 242 or 244 and determines whether there are other rear zones at 246. If 246 is true, the method selects the next zone at 250 and returns to 238. If 246 is false, the method ends.

Referring now to FIG. 4, a method for determining if a particular one of the zones is occupied is shown. At 310, the method determines whether there is a door ajar event for the corresponding zone. If 310 is true, the method determines whether the occupant classifier detects the passenger and/or a seat belt is buckled at 314. If 314 is true, the method declares that an occupant is in the corresponding zone at 340. If either 310 or 314 are false, the method determines whether there is a camera available for the zone at 318. If 318 is true, the method continues at 322 and performs image analysis to detect whether an occupant is present in the zone. If either 318 or 322 are false, the method declares that an occupant is not in the corresponding zone at 326. If 322 is true, the method continues at 340 and declares an occupant in the zone.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A vehicle comprising:
a driver seat zone;
a passenger seat zone including a passenger seat lighting system and a passenger seat occupant sensor; and
a lighting control module configured to:
operate in a first lighting mode and a second lighting mode;
in the first lighting mode, supply power to the passenger seat lighting system during operation of the vehicle; and
in the second lighting mode, supply power to the passenger seat lighting system in response to the passenger seat occupant sensor sensing a passenger in the passenger seat zone during operation of the vehicle and not supply power to the passenger seat lighting system in response to the passenger seat occupant sensor not sensing the passenger in the passenger seat zone during operation of the vehicle.

2. The vehicle of claim 1, wherein the passenger seat occupant sensor is selected from a group consisting of a door sensor, a seat belt sensor, a camera, and an occupant classifier.

3. The vehicle of claim 1, wherein:
the passenger seat occupant sensor includes a passenger door sensor and at least one of a passenger seat belt sensor and an occupant classifier, and
the passenger seat occupant sensor senses the passenger in the passenger seat zone in response to the passenger door sensor sensing a door ajar event and at least one of the passenger seat belt sensor sensing a seat buckle event and the occupant classifier sensing the passenger.

4. The vehicle of claim 3, wherein:
the passenger seat occupant sensor further includes a camera and an image analysis module configured to identify a passenger in one or more images from the camera, and
the passenger seat occupant sensor senses the passenger in the passenger seat zone in response to the camera and the image analysis module.

5. The vehicle of claim 1, further comprising:
a rear seat zone;
a rear seat lighting system; and
a rear seat occupant sensor,
wherein the lighting control module is further configured to:
in the first lighting mode, supply power to the rear seat lighting system during operation of the vehicle; and
in the second lighting mode, supply power to the rear seat lighting system in response to the rear seat occupant sensor sensing a passenger in the rear seat zone during operation of the vehicle and not supply power to the rear seat lighting system in response to the rear seat occupant sensor not sensing the passenger in the rear seat zone during operation of the vehicle.

6. The vehicle of claim 5, wherein the rear seat occupant sensor is selected from a group consisting of a door sensor, a seat belt sensor, a camera, and an occupant classifier.

7. The vehicle of claim 6, wherein:
the rear seat occupant sensor includes a rear door sensor and a rear seat belt sensor, and
the rear seat occupant sensor senses the passenger in the rear seat zone in response to the door sensor sensing a door ajar event and at least one of the seat belt sensor sensing a seat buckle event and the occupant classifier sensing the passenger.

8. The vehicle of claim 3, wherein:
the passenger seat occupant sensor further includes a camera and an image analysis module configured to identify a passenger in one or more images from the camera, and
the passenger seat occupant sensor senses the passenger in the passenger seat zone in response to the camera and the image analysis module.

9. The vehicle of claim 5, wherein at least one of the passenger seat lighting system and the rear seat lighting system includes a red, green, and blue (RGB) light emitting diode (LED).

10. A vehicle comprising:
a passenger seat zone including a passenger user experience enhancement device and a passenger seat occupant sensor; and
a control module configured to:
operate in a first mode and a second mode;
in the first mode, supply power to the passenger user experience enhancement device during operation of the vehicle; and
in the second mode, supply power to the passenger user experience enhancement device in response to the passenger seat occupant sensor sensing a passenger in the passenger seat zone during operation of the vehicle and not supply power to the passenger user experience enhancement device in response to the passenger seat occupant sensor not sensing the passenger in the passenger seat zone during operation of the vehicle.

11. The vehicle of claim 10, wherein the passenger user experience enhancement device is selected from a group consisting of a lighting system, a perfume dispensing device, and a display.

12. The vehicle of claim 10, wherein the passenger seat occupant sensor is selected from a group consisting of a door sensor, a seat belt sensor, a camera, and an occupant classifier.

13. The vehicle of claim 12, wherein:
the passenger seat occupant sensor includes the door sensor and the seat belt sensor, and
the passenger seat occupant sensor senses the passenger in the passenger seat zone in response to the door sensor sensing a door ajar event and at least one of the seat belt sensor sensing a seat buckle event and the occupant sensor sensing the passenger.

14. The vehicle of claim 13, wherein:
the passenger seat occupant sensor further includes a camera and an image analysis module configured to identify a passenger in one or more images from the camera, and
the passenger seat occupant sensor senses the passenger in the passenger seat zone in response to the camera and the image analysis module.

15. The vehicle of claim 10, further comprising:
a rear seat zone;
a rear seat user experience enhancement device; and
a rear seat occupant sensor.

16. The vehicle of claim 15, wherein the control module is further configured to:
in the first mode, supply power to the rear seat user experience enhancement device during operation of the vehicle; and
in the second mode, supply power to the rear seat user experience enhancement device in response to the rear seat occupant sensor sensing a passenger in the rear seat zone during operation of the vehicle and not supply power to the rear seat user experience enhancement device in response to the rear seat occupant sensor not sensing the passenger in the rear seat zone during operation of the vehicle.

17. The vehicle of claim 16, wherein the rear seat occupant sensor is selected from a group consisting of a door sensor, a seat belt sensor, a camera, and an occupant classifier.

18. The vehicle of claim 17, wherein:
the rear seat occupant sensor includes a rear door sensor and a rear seat belt sensor, and
the rear seat occupant sensor senses the passenger in the rear seat zone in response to the rear door sensor sensing a door ajar event and at least one of the rear seat belt sensor sensing a seat buckle event and the occupant classifier sensing the passenger.

19. The vehicle of claim 18, wherein the rear seat occupant sensor further includes:
a camera; and
an image analysis module configured to identify a passenger in one or more images from the camera, wherein the rear seat occupant sensor senses the passenger in the passenger seat zone in response to the camera and the image analysis module.

20. A vehicle comprising:
a driver seat zone;
a passenger seat zone including a passenger seat lighting system and a passenger seat occupant sensor, wherein the passenger seat occupant sensor is selected from a group consisting of a door sensor, a seat belt sensor, a camera, and an occupant classifier;
a rear seat zone including a rear seat lighting system and a rear seat occupant sensor, wherein the rear seat occupant sensor is selected from a group consisting of a door sensor, a seat belt sensor, a camera, and an occupant classifier; and
a lighting control module configured to:
operate in a first lighting mode and a second lighting mode;
in the first lighting mode, supply power to the passenger seat lighting system and the rear seat lighting system during operation of the vehicle; and
in the second lighting mode:
supply power to the passenger seat lighting system in response to the passenger seat occupant sensor sensing a passenger in the passenger seat zone during operation of the vehicle,
not supply power to the passenger seat lighting system in response to the passenger seat occupant sensor not sensing the passenger in the passenger seat zone during operation of the vehicle;
supply power to the rear seat lighting system in response to the rear seat occupant sensor sensing a passenger in the rear seat zone during operation of the vehicle,
not supply power to the rear seat lighting system in response to the rear seat occupant sensor not sensing the passenger in the rear seat zone during operation of the vehicle,
wherein at least one of the passenger seat lighting system and the rear seat lighting system includes a red, green, and blue (RGB) light emitting diode (LED).
